(19) United States
(12) Patent Application Publication
(10) Pub. No.: US 2023/0226930 A1
(43) Pub. Date: Jul. 20, 2023

(54) A METHOD FOR CONNECTING ONE OR MORE ELECTRIC BATTERY UNITS TO AN ELECTRICAL SYSTEM

(71) Applicant: Scania CV AB, Södertälje (SE)

(72) Inventors: Peter ENGSTRAND, Älvsjö (SE); Kent KVARNSTRÖM, Södertälje (SE); Mathias BJÖRKMAN, Tullinge (SE); Rasmus LÖFSTRAND GRIP, Hägersten (SE); Andreas ZAFEIROPOULOS, Athens (GR); Robert JADEBORG, Södertälje (SE)

(73) Assignee: Scania CV AB, Södertälje (SE)

(21) Appl. No.: 18/010,524

(22) PCT Filed: Jun. 24, 2021
(86) PCT No.: PCT/SE2021/050628

§ 371 Date: Dec. 15, 2022

(30) Foreign Application Priority Data
Jul. 1, 2020 (SE) 2050813-1

(51) Int. Cl. B60L 50/64; B60L 3/00; H02H 7/18

(52) U.S. Cl. CPC B60L 50/64; B60L 3/0046; H02H 7/18

(57) ABSTRACT

The invention relates to a method for connecting one or more electric battery units to an electrical system. The method comprises: maintaining a system short-circuit which short-circuits the electrical system; while the system short-circuit is maintained, electrically connecting a first electric battery unit, which is locally short-circuited by a local short-circuit, to the electrical system so as to include the first electric battery unit in the electrical system; and while the system short-circuit is maintained, removing the local short-circuit of the first electric battery unit, whereupon the first electric battery unit is short-circuited by the system short-circuit of the electrical system. The method may be performed as a part of an electrical system installation procedure in for example a hybrid or electric vehicle and allows the electric battery units to be connected to the electrical system in a safe way.

### CROSS-REFERENCE TO RELATED APPLICATIONS

This application is a National Stage Patent Application (filed under 35 § U.S.C. 371) of PCT/SE2021/050628, filed Jun. 24, 2021, of the same title, which, in turn claims priority to Swedish Patent Application No. 2050813-1 filed Jul. 1, 2020, of the same title; the contents of each of which are hereby incorporated by reference.

### FIELD OF THE INVENTION

Aspects of the present invention relate to a method for connecting one or more electric battery units to an electrical system.

### BACKGROUND OF THE INVENTION

An electric battery cell can be seen as a container chemically storing energy. The electric battery cells may come in various forms and shapes. The electric battery cells may be connected in series and in parallel, into an electric battery arrangement, which may be called an electric battery pack, in order to attain the desired voltage and energy capacity. A conventional electric battery pack may be the complete enclosure or unit that delivers electric power to a product or equipment, for example an electrical vehicle or a hybrid vehicle. When used in a hybrid vehicle or an electric vehicle, the electric battery pack may be connected to a vehicle electrical system of the vehicle, which may be called a vehicle high voltage system (VCB). The vehicle electrical system transfers electric power or electric current between various electrical apparatuses or units included in the hybrid vehicle or the electric vehicle.

### SUMMARY OF THE INVENTION

Great care must be observed when connecting battery packs to electrical systems to avoid electrical hazard, especially in high voltage systems such as for example vehicle high voltage systems (VCBs). Conventionally, the voltage in the VCB and/or battery pack has been measured before connecting the battery pack to the VCB or finger proof connectors have been used to protect the person installing the battery pack. The inventors of the present invention have found drawbacks in the use of conventional methods which requires high electrical competence when connecting the battery pack to the electrical system, for example during vehicle manufacturing.

An object of embodiments of the invention is to provide a solution which mitigates or solves drawbacks and problems of conventional solutions.

The above and further objects are solved by the subject matter of the independent claim. Further advantageous embodiments of the invention can be found in the dependent claims.

According to a first aspect of the invention, the above mentioned and other objects are achieved with a method for connecting one or more electric battery units to an electrical system, the electric battery unit having two terminals, wherein the method comprises:
maintaining a system short-circuit which short-circuits the electrical system;
when the system short-circuit is maintained, electrically connecting a first electric battery unit, which is locally short-circuited by a local short-circuit, to the electrical system so as to include the first electric battery unit in the electrical system; and
when the system short-circuit is maintained, removing the local short-circuit of the first electric battery unit, whereupon the first electric battery unit is short-circuited by the system short-circuit of the electrical system.

An advantage of the method according to the first aspect is that it allows electric battery units to be safely connected to an electrical system, for example during an installation procedure. The local short-circuit together with the system short-circuit ensures that the electrical hazard is minimized during the connection. Thus, electric battery units can be safely connected to an electrical system even by laymen with no or low electrical competence. The method is especially advantageous when used to connect high voltage battery units to vehicle high voltage system (VCBs) where the electric power, or the electric current, is transferred at a high voltage, for example above 60 V, such as above 400 V. The electric power, or the electric current, of the vehicle high voltage system (VCB) may be transferred at a voltage up to 1500 V. Furthermore, the method allows the one or more electric battery units to be connected to the electrical system without any voltage measurement or other precautions. The installation time of the one or more electric battery units can thereby be reduced.

According to an advantageous embodiment of the method according to the first aspect, the method comprises:
receiving the first electric battery unit already locally short-circuited by the local short-circuit.

An advantage of this embodiment is that the first electric battery unit can be safely handled already from delivery and the risk of exposure to live wires is minimized.

According to an advantageous embodiment of the method according to the first aspect, the method comprises:
locally short-circuiting the first electric battery unit so as to establish the local short-circuit of the first electric battery unit.

An advantage of this embodiment is that it allows first electric battery units not locally short-circuited when delivered to be handled in a safe way. Thereby, increasing the flexibility of the method.

According to an advantageous embodiment of the method according to the first aspect, the step of electrically connecting the first electric battery unit comprises electrically connecting a first electric battery unit which comprises two terminals which are short-circuited by the local short-circuit. An advantage of this embodiment is that short-circuiting of the first electric battery unit can be achieved in a simple and straight-forward way.

According to an advantageous embodiment of the method according to the first aspect, the method comprises:
receiving the first electric battery unit with the two terminals already locally short-circuited by the local short-circuit.

According to an advantageous embodiment of the method according to the first aspect, the method comprises:
locally short-circuiting the two terminals of the first electric battery unit so as to establish the local short-circuit of the first electric battery unit.

According to an advantageous embodiment of the method according to the first aspect, the step of removing the local short-circuit of the first electric battery unit is performed by removing an electrically conductive member, which when applied is short-circuiting the two terminals of the first electric battery unit. An advantage of this embodiment is that short-circuiting of the first electric battery unit can be removed in a simple and straight-forward way. Alternatively, the step of removing the local short-circuit may be performed in other manners. For example, the step of removing the local short-circuit may be performed by changing a setting of a switch, for example an internal switch, of the first electric battery unit without any physical removal of any electrically conductive member from the first electric battery unit.

According to an advantageous embodiment of the method, the electrically conductive member is external to the first electric battery unit when the electrically conductive member is applied to the first electric battery unit. In alternative embodiments, the electrically conductive member may be internal in relation to the first electric battery unit when the electrically conductive member is applied to the first electric battery unit.

According to an advantageous embodiment of the method according to the first aspect, the connection of the first electric battery unit is part of an electrical system installation procedure, and wherein the removal of the local short-circuit of the first electric battery unit is performed during the electrical system installation procedure. An advantage of this embodiment is an improved electrical system installation procedure which is safe and which reduces the installation time.

According to an advantageous embodiment of the method according to the first aspect, the step of electrically connecting the first electric battery unit, which is locally short-circuited by the local short-circuit, to the electrical system is performed before the step of removing the local short-circuit of the first electric battery unit. An advantage of this embodiment is that the first electric battery unit is maintained short-circuited during the procedure, i.e. there is no point in time when the first battery unit is not short-circuited. The electrical hazard during the procedure is thereby minimized.

According to an advantageous embodiment of the method according to the first aspect, the step of removing the local short-circuit of the first electric battery unit, which is locally short-circuited by the local short-circuit, is performed before the step of electrically connecting the first electric battery unit to the electrical system. An advantage of this embodiment is that it allows the local short-circuit to be established or applied to the same terminals of the first electric battery unit which are then used to connect the first electric battery unit to the electrical system. Thereby, increasing the flexibility of the method.

According to an advantageous embodiment of the method according to the first aspect, the method comprises:
when the system short-circuit is maintained, and after to the step of electrically connecting the first electric battery unit to the electrical system and after the step of removing the local short-circuit of the first electric battery unit, electrically connecting a further electric battery unit, which is locally short-circuited by a local short-circuit, to the electrical system so as to include the further electric battery unit in the electrical system; and
when the system short-circuit is maintained, and after to the step of electrically connecting the first electric battery unit to the electrical system and after the step of removing the local short-circuit of the first electric battery unit, removing the local short-circuit of the further electric battery unit, whereupon the further electric battery unit is short-circuited by the system short-circuit of the electrical system.

An advantage of this embodiment is that more than one electric battery unit can be connected to the electrical system, thereby increasing the flexibility of the method. The embodiments for connecting one or more further electric battery unit, described below, correspond to the previously described embodiments for connecting the first electric battery unit and hence brings the same advantages as the corresponding embodiments for the first electric battery unit.

According to an advantageous embodiment of the method according to the first aspect, the method comprises:
receiving the further electric battery unit already locally short-circuited by the local short-circuit.

According to an advantageous embodiment of the method according to the first aspect, the method comprises:
locally short-circuiting the further electric battery unit so as to establish the local short-circuit of the further electric battery unit.

According to an advantageous embodiment of the method according to the first aspect, the step of electrically connecting the further electric battery unit comprises electrically connecting a further electric battery unit which comprises two terminals which are short-circuited by the local short-circuit.

According to an advantageous embodiment of the method according to the first aspect, the method comprises:
receiving the further electric battery unit with the two terminals already locally short-circuited by the local short-circuit.

According to an advantageous embodiment of the method according to the first aspect, the method comprises:
locally short-circuiting the two terminals of the further electric battery unit so as to establish the local short-circuit of the further electric battery unit.

According to an advantageous embodiment of the method according to the first aspect, the step of removing the local short-circuit of the further electric battery unit is performed by removing an electrically conductive member, which when applied is short-circuiting the two terminals of the further electric battery unit. Alternatively, the step of removing the local short-circuit may be performed in other manners. For example, the step of removing the local short-circuit may be performed by changing a setting of a switch, for example an internal switch, of the further electric battery unit without any physical removal of any electrically conductive member from the further electric battery unit.

According to an advantageous embodiment of the method, the electrically conductive member, which when is short-circuiting the two terminals of the further electric battery unit, is external to the further electric battery unit when the electrically conductive member is applied to the further electric battery unit. In alternative embodiments, the electrically conductive member may be internal in relation to the further electric battery unit when the electrically conductive member is applied to the further electric battery unit.

According to an advantageous embodiment of the method according to the first aspect, the connection of the further electric battery unit is part of an electrical system installation procedure, and wherein the removal of the local short-circuit of the further electric battery unit is performed during the electrical system installation procedure.

According to an advantageous embodiment of the method according to the first aspect, the step of electrically connecting the further electric battery unit, which is locally short-circuited by the local short-circuit, to the electrical system is performed before the step of removing the local short-circuit of the further electric battery unit.

According to an advantageous embodiment of the method according to the first aspect, the step of removing the local short-circuit of the further electric battery unit, which is locally short-circuited by the local short-circuit, is performed before the step of electrically connecting the further electric battery unit to the electrical system.

According to an advantageous embodiment of the method according to the first aspect, the method comprises removing the system short-circuit of the electrical system after one or more of the steps of the following group of steps:
electrically connecting the first electric battery unit and removing the local short-circuit of the first electric battery unit; and
electrically connecting the further electric battery unit and removing the local short-circuit of the further electric battery unit.

An advantage of this embodiment is that the system short-circuit of the electrical system is not removed before the first and/or further battery unit is/are connected and the local short-circuit have been removed. The method thereby provides increased safety.

According to an advantageous embodiment of the method according to the first aspect, the step of removing the system short-circuit is performed by removing a second electrically conductive member which when applied is short-circuiting the electrical system. An advantage of this embodiment is that short-circuiting of the electrical system can be removed in a simple and straight-forward way In alternative embodiments, instead of removing the second electrically conductive member, the step of removing the system short-circuit can include or involve changing a setting of the electrical system.

According to an advantageous embodiment of the method according to the first aspect, the step of removing the system short-circuit is performed when one or more of the situations of the following group of situations is/are valid:
no galvanically exposed electrical conductor present in the electrical system;
a circuit breaker, which is included in and electrically connected to the electrical system and is switchable between an open position and a closed position, is in the open position;
one or more contactors, the contactor being included in one or more of the first and further electric battery units and switchable between an open position and a closed position, is/are in the open position; and
a component interrupts the electrical conductivity in the electrical system

An advantage of this embodiment is that the system short-circuit of the electrical system is not removed before it has been verified that it is safe to do so.

According to an advantageous embodiment of the method according to the first aspect, the method comprises:
before maintaining the system short-circuit of the electrical system, short-circuiting the electrical system so as to establish the system short-circuit of the electrical system.

An advantage of this embodiment is that the electrical system is safe at when the procedure is started. Before short-circuiting the electrical system, it may be assured that no electric battery unit is electrically connected to the electrical system. Alternatively, or in additional thereto, before short-circuiting the electrical system, it may be assured that an electric battery unit, which is electrically connected to the electrical system and is included in the electrical system, is locally short-circuited by a local short-circuit. Alternatively, or in additional thereto, before short-circuiting the electrical system, it may be assured that one or more contactors of the electric battery unit is/are open, i.e. in an open position for interrupting an electric current path in the electric battery unit.

According to an advantageous embodiment of the method according to the first aspect, the electrical system is a vehicle electrical system of a vehicle or a vehicle high voltage system of a vehicle. An advantage of this embodiment is that the method can be used to safely connect one or more electric battery units to a vehicle electrical system or a vehicle high voltage system.

According to an advantageous embodiment of the method according to the first aspect, one or more of the first and further electric battery units comprises/comprise any one of the group of:
an electric battery, and
an electric battery pack.

An advantage of this embodiment is that the method can be used to safely install different types of electric battery units.

The above-mentioned features and embodiments of method may be combined in various possible ways providing further advantageous embodiments.

Further advantageous embodiments of the method according to the present invention and further advantages with the embodiments of the present invention emerge from the detailed description hereinbelow.

### BRIEF DESCRIPTION OF THE DRAWINGS

Embodiments of the invention will now be illustrated, for exemplary purposes, in more detail by way of embodiments and with reference to the enclosed drawings, where similar references are used for similar parts, in which:

FIG. 1 schematically illustrates a flow chart of a method according to embodiments of the invention;

FIGS. 2a-d schematically illustrate the steps of connecting a battery unit to an electrical system according to embodiments of the invention;

FIG. 3 schematically illustrates an example of an electric battery unit;

FIG. 4 is a schematic diagram illustrating an example of an electric battery pack; and

FIG. 5 schematically illustrates an example of a vehicle comprising a vehicle electrical system.

### DETAILED DESCRIPTION OF THE INVENTION

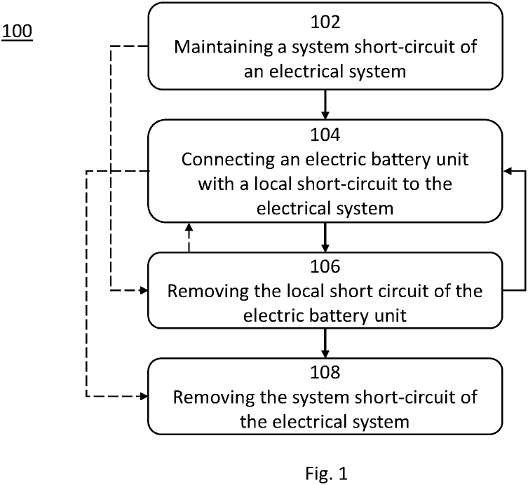

FIG. 1 schematically illustrates a flow chart of a method 100 according to an embodiment of the invention. The method 100 may be performed to connect one or more electric battery units to an electrical system, for example as a part of an electrical system installation procedure. The method 100 allows the one or more electric battery units to be connected to the electrical system in a safe way by minimizing the electrical hazard.

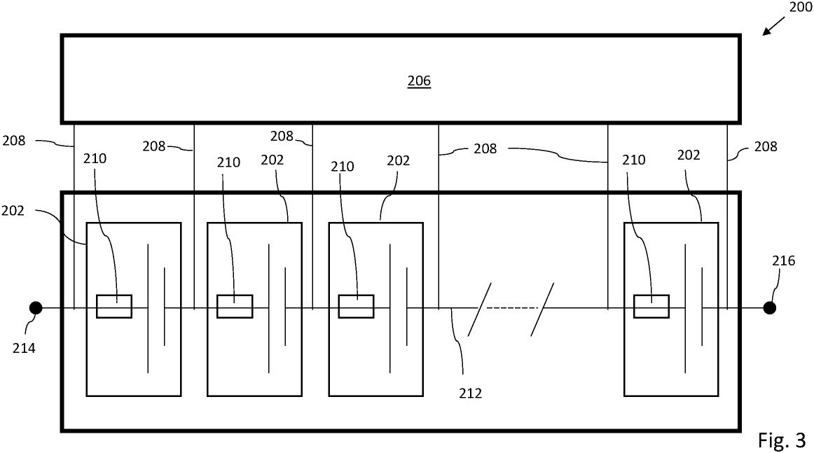

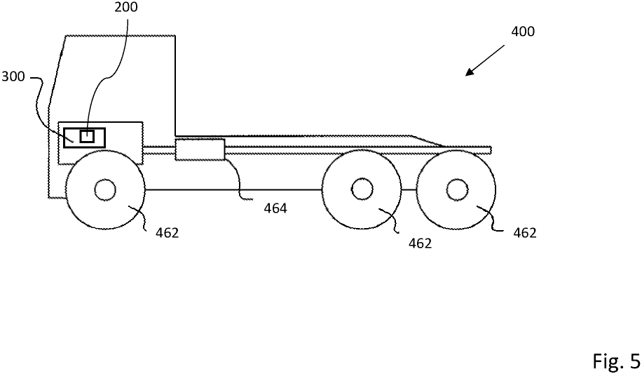

The one or more electric battery units may comprise one or more electric battery cells which may be arranged in one or more electric battery modules and may further be referred to as an electrical battery or electric battery pack. Each electric battery unit may be an electric battery unit such as the electrical battery unit 200 schematically illustrated in FIG. 3. In embodiments, the electrical system is a vehicle electrical system of a vehicle such as for example the vehicle electrical system 300 shown in FIG. 5, which may be referred to as a vehicle high voltage system. However, the method 100 can also be used to connect other types of electric battery units to other types of electrical systems.

With reference to FIG. 1, the method 100 comprises maintaining 102 a system short-circuit which short-circuits the electrical system. The step of maintaining 102 the system short-circuit may comprise maintaining/keeping the electrical system short-circuited with a system short-circuit which has been previously established for the electrical system or applied to the electrical system. The electrical system may for example be delivered with a system short-circuit or the system short-circuit may be established/applied in an optional step (not shown in Figs.) performed before the step 102.

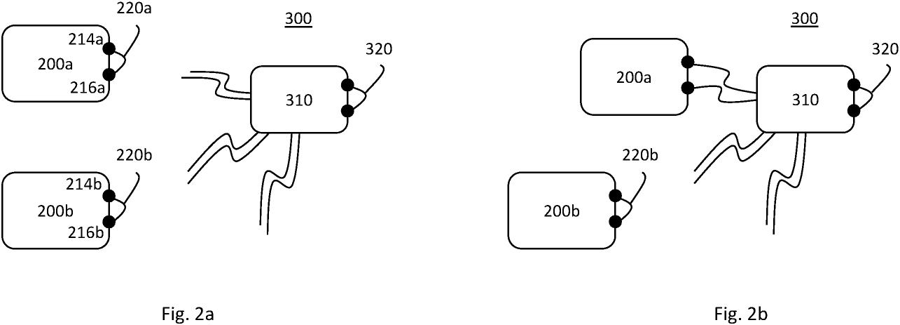

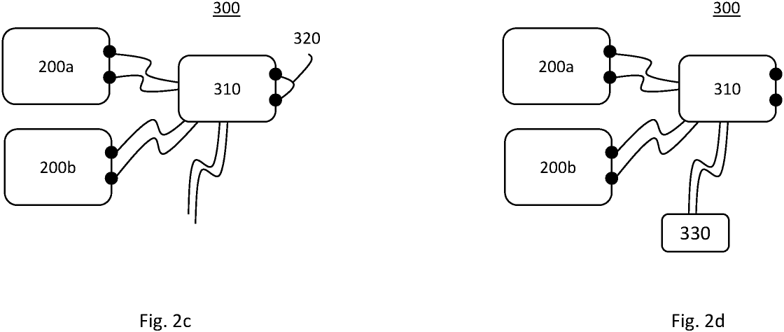

The system short-circuit may be provided with an electrically conductive member (e.g. a second electrically conductive member), which is short-circuiting at least parts of the electrical system when established or applied. The electrically conductive member may comprise or consist of a metal or metal alloy. Alternatively, the system short-circuit may be provided by changing a setting of a switch comprised in the electrical system or capable of controlling the current through the electrical system. An example of an electrically conductive member used for short-circuiting the electrical system 300 is shown e.g. in FIG. 2a. In the embodiment shown in FIG. 2a, the system short-circuit which short-circuits the electrical system 300 is applied to a component/part/circuit 310 of the electrical system 300 and is an electrically conductive member 320 such as for example a wire/plate/bracket/shackle.

With reference to FIG. 1, the method 100 further comprises, when the system short-circuit is maintained, electrically connecting 104 an electric battery unit (e.g. a first electrical battery unit), which is locally short-circuited by a local short-circuit, to the electrical system so as to include the electric battery unit in the electrical system. In general, the electric battery unit comprises two terminals (shown e.g. in FIG. 3) and the electric battery unit may be locally short-circuited by short-circuiting the two terminals with the local short-circuit. Thus, the step of electrically connecting 104 the electric battery unit may comprise electrically connecting an electric battery unit which comprises two terminals which are short-circuited by the local short-circuit.

In embodiments, the electrical connection of the electric battery unit is part of an electrical system installation procedure. The step of electrically connecting 104 the electric battery unit to the electrical system may hence be performed during an installation procedure for installing the electrical system. For example, during the installation of the electrical system in a product or equipment, such as an electrical vehicle or a hybrid vehicle.

The local short-circuit of the electric battery unit may be provided with an electrically conductive member, which is short-circuiting the two terminals of the electric battery unit when established or applied. The electrically conductive member may be external to the electric battery unit when the electrically conductive member is applied to the electric battery unit. In alternative embodiments, the electrically conductive member may be internal in relation to the electric battery unit when the electrically conductive member is applied to the electric battery unit. The internal electrically conductive member may, for example, be located behind a hatch when it is applied to the electric battery unit. The electrically conductive member may be arranged to be releasable attached to electric battery unit and may comprise or consist of a metal or metal alloy. Alternatively, the local short-circuit of the electric battery unit may be provided by changing a setting of a switch, for example an internal switch, of the electric battery unit. An example of an electrically conductive member used for short-circuiting a first battery unit 200a is shown in FIG. 2a. In the embodiment shown in FIG. 2a, the local short-circuit which short-circuits the first battery unit 200a is an electrically conductive member 220a such as for example a wire/plate/bracket/shackle applied to the two terminal 214a, 216a of first battery unit 200a. The electrically conductive member may be equipped with an electrically isolated grip or handle for an operator, or user, to grip in order to operate the electrically conductive member.

Furthermore, the local short-circuit of the electric battery unit may be established at different stages, for example in connection with the manufacturing of the electrical battery unit, upon delivery of the electrical battery unit, during the installation of the electrical battery unit, etc. In embodiments, the electric battery unit is obtained already locally short-circuited. In this case, the method 100 may comprise an optional receiving step before the step of connecting 104 the electrical battery unit, in which the electric battery unit is received already locally short-circuited by the local short-circuit. The receiving step may further comprise receiving the electric battery unit with the two terminals already locally short-circuited by the local short-circuit.

Alternatively, the electric battery unit may be locally short-circuited as part of the method 100. The method 100 may hence in embodiments comprise a step of locally short-circuiting the electric battery unit so as to establish the local short-circuit of the electric battery unit. The step of locally short-circuiting the electric battery unit may comprise locally short-circuiting the two terminals of the electric battery unit so as to establish the local short-circuit of the electric battery unit .The step of locally short-circuiting the electric battery unit is, when present, performed before the step of connecting 104 the electrical battery unit.

The method 100 further comprises, when the system short-circuit is maintained, removing 106 the local short-circuit of the electric battery unit, whereupon the first electric battery unit is short-circuited by the system short-circuit of the electrical system. In embodiments where the electrical connection of the electric battery unit is part of an electrical system installation procedure, the removal of the local short-circuit of the electric battery unit is performed during the electrical system installation procedure.

In embodiments where the local short-circuit of the electric battery unit is provided with an electrically conductive member, the step of removing 106 the local short-circuit of the electric battery unit is performed by physically removing the electrically conductive member. The step of removing 106 the local short-circuit may hence be performed by physically removing an item that is short-circuiting the two terminals of the electric battery unit. Alternatively, the step of removing 106 the local short-circuit may be performed by changing a setting of a switch, for example an internal switch, of the electric battery unit without any physical removal of any electrically conductive member from the electric battery unit.

In the flow chart shown in FIG. 1, the step of electrically connecting 104 the electric battery unit, which is locally short-circuited by the local short-circuit, to the electrical system is performed before the step of removing 106 the local short-circuit of the electric battery unit. The electric battery unit may hence after being connected and before the local short-circuit is being removed be short-circuited by both the local short-circuit and the system short-circuit and after the local short-circuit has been removed short-circuited by the system short-circuit.

However, in embodiments the step of removing 106 the local short-circuit of the electric battery unit, which is locally short-circuited by the local short-circuit, may instead be performed before the step of electrically connecting 104 the electric battery unit to the electrical system. The steps of the method 100 will then be performed in the order indicated by the dashed arrows in FIG. 1. The step of removing 106 may for example be performed before the step of electrically connecting 104 when the two terminals of the electric battery unit are used for both the local short-circuit and connecting the electric battery unit to the electrical system. When the local short-circuit of the electric battery unit is removed before connecting the electric battery unit to the electrical system, the electrical battery unit is not short-circuited during the time between the two steps. Once connected to the electrical system, the electric battery unit is short-circuited by the system short-circuit. Thus, the electric battery unit is short-circuited by the system short-circuit of the electrical system upon the electrical connection of the electric battery unit or upon the removal of the local short-circuit of the electric battery unit.

The method 100 may be used to connect more than one electric battery unit to the electrical system. In this case, the step of electrically connecting 104 an electric battery unit and the step of removing 106 the local short-circuit of the electric battery unit may be repeated for a further electrical battery unit (e.g. a second electrical battery unit, a third electrical unit, etc.), while maintaining the system short-circuit. When the steps of the method 100 are performed in the order shown in FIG. 1, this means that after the step of electrically connecting 104 the electric battery unit which is locally short-circuited by the local short-circuit and after the step of removing 106 the local short-circuit of the electric battery unit have been performed, the method 100 goes back to step 104, as indicated by the arrow from step 106 to step 104, and performs step 104 and 106 for a further electric battery unit. Thus, while the system short-circuit is maintained, a further electric battery unit, which is locally short-circuited by a local short-circuit, is electrically connected to the electrical system in step 104 so as to include the further electric battery unit in the electrical system. Furthermore, the local short-circuit of the further electric battery unit is removed in step 106, whereupon the further electric battery unit is short-circuited by the system short-circuit of the electrical system.

With reference to FIG. 1, the method 100 may further comprise removing 108 the system short-circuit of the electrical system after electrically connecting the one or more electric battery units and removing the local short-circuit of the one or more electric battery units. The removing 108 the system short-circuit may be excluded and performed at a later stage. In embodiments where the system short-circuit is an electrically conductive member (e.g. a second electrically conductive member), the step of removing 108 the system short-circuit may be performed by physically removing the electrically conductive member which when applied is short-circuiting the electrical system. Alternatively, the system short-circuit may be removed by changing a setting of a switch comprised in the electrical system or capable of controlling the current through the electrical system

The system short-circuit may be removed when it is determined that it is safe to remove the system short-circuit, for example when the installation of the electrical system is completed and there are not live wires in the electrical system. The step of removing 108 the system short-circuit may be performed when one or more of the situations of the following group of situations is/are valid:
no galvanically exposed electrical conductor is present in the electrical system;
a circuit breaker, which is included in and electrically connected to the electrical system and is switchable between an open position and a closed position, is in the open position;
one or more contactors, the contactor being included in one or more of the electric battery units and switchable between an open position and a closed position, is/are in the open position; and
a component interrupts the electrical conductivity in the electrical system.

In general, the electric battery or electric battery pack is provided with the one and more contactors. When each of the contactors and the circuit breaker is in the closed position, each of the contactors and the circuit breaker is configured to conduct an electric current or allow an electric current to pass. When each of the contactors and the circuit breaker is in the open position, each of the contactors and the circuit breaker is configured to prevent/stop an electric current such that no electric current can pass through the contactor or circuit breaker.

FIGS. 2a-d schematically illustrates the steps of connecting a first battery unit 200a and a second battery unit 200b to an electrical system 300 according to embodiments of the invention. FIG. 2a shows the first and second battery units 200a, 200b disconnected from the electrical system 300, i.e. the situation before the first and second battery units 200a, 200b are connected to the electrical system 300.

With reference to FIG. 2a, the first and second battery units 200a, 200b are locally short-circuited by a respective local short-circuit 220a, 220b and the electrical system is short-circuited by a system short-circuit 320 established or applied to a component 310 of the electrical system 300. The local short-circuits 220a, 220b and the system short-circuit 320 are in FIGS. 2 illustrated as electrically conductive members which provides a short-circuit between two terminals of the first and second battery units 200a, 200b and the component 310, respectively, but are as previously described not limited thereto.

In FIG. 2b, the first battery unit 200a has been connected to the electrical system 300 and the local short-circuit 220a has been removed. In other words, the steps of electrically connecting 104 and removing 106 have been performed for the first battery unit 200a. The local short-circuit 220a may be removed either before or after the first battery unit 200a has been electrically connected to the electrical system 300. In either case, the local short-circuit 220a may be removed in conjunction with the connection to the electrical system 300, i.e. within a short time window. In the shown embodiment, the local short-circuit 220a is connected to the two terminal 214a, 216a of the first battery unit 200a which are also used for electrical connection to the electrical system 300. In this case, the local short-circuit 220a may be removed before the electrical connection to the electrical system 300 to make the two terminals 214a, 216a available for electrical connection to the electrical system 300. The local short-circuit 220a may then be removed shortly before electrically connecting the first battery unit 200a to the electrical system 300 to minimize the time during which the first battery unit 200a is not short-circuited.

In FIG. 2c, the second battery unit 200b has also been electrically connected to the electrical system 300 and the local short-circuit 220b has been removed. In other words, the steps of electrically connecting 104 and removing 106 have been performed also for the second battery unit 200b. The electrical system 300 is still short-circuited by the system short-circuit 320, i.e. the system short-circuit 320 is maintained.

FIG. 2d shows the situation when the electrical system is installed and it has been determined that it is safe to remove the system short-circuit 320. The full installation may for example have been completed and there are no galvanically exposed electrical conductor present in the electrical system 300 and/or optionally a circuit breaker 330 may have been connected to the electrical system and is in an open position. Hence, the system short-circuit 320 has been removed from the electrical system 300, as indicated in FIG. 2d.

FIG. 3 schematically illustrates an example of an electrical battery unit 200 which can be connected to an electrical system using the method 100 according to the invention. The electrical battery unit 200 may include one or more electric battery cells 202 which may be arranged in a module. Each electric battery cell 202 can be seen as a container chemically storing energy and may be a rechargeable electric battery cell. The electrical battery cell 202 may for example be a Li-ion battery cell or a NiMH battery cell but are not limited thereto. The electric battery cells 202 may be electrically connected in series and in parallel, into the electric battery unit 200, which may be called an electric battery pack, in order to attain the desired voltage and energy capacity. In shown embodiment, the electric battery cells 202 are electrically connected in series with one another and are part of a main power line 212. The electric battery unit 200 or pack may form the complete enclosure or unit that delivers electric power to a product or equipment, for example an electrical vehicle or a hybrid vehicle such as the vehicle 400 shown in FIG. 5.

With reference to FIG. 3, the electric battery unit 200 includes a cell controller 206 which is electrically connected in parallel with each electric battery cell 202 by way of a plurality of electrical lines 208, for example electrical wires. The cell controller 206 may be called a cell module controller (CMC). Each electric battery cell 202 may include a cell fuse 210 for short-circuit protection. However, in some arrangements, the cell fuse 210 may be excluded from the electric battery cell 202.

In general, the electrical battery unit 200 has two terminals 214, 216 for connecting the electrical battery unit 200 to an electrical system. The two terminals 214, 216 may be disclosed as electrical contacts. One of the two terminals 214, 216 may be a negative terminal having a negative pole, while the other one of the two terminals 214, 216 may be a positive terminal having a positive pole.

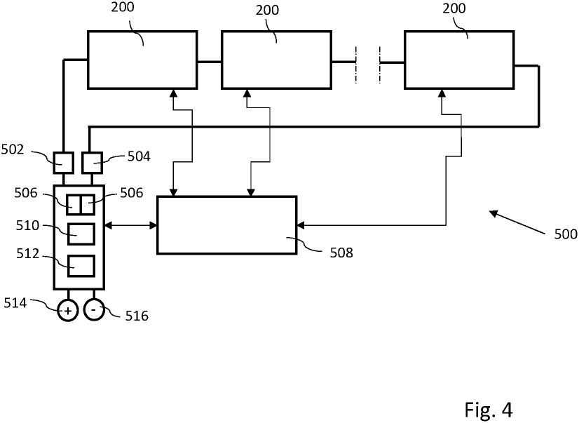

The unit 200 illustrated in FIG. 3 may also represent an electric battery module 200 included in an electric battery pack 500 schematically illustrated in FIG. 4, wherein the electric battery pack 500 may represent the first electric battery unit and/or the further electric battery unit. With reference to FIG. 4, the electric battery pack 500 may comprise a plurality of electric battery modules 200 which may be electrically connected in series and have two common outputs 502, 504 (positive and negative) for electric power, or current, transfer. The electric battery pack 500 may have two terminals 514, 516 (DC positive and DC negative) for electric power, or current, transfer, to be connected to the electrical system. The above-mentioned two common outputs 502, 504 are connected to the two terminals 514, 516 of the electric battery pack 500.

With reference to FIG. 4, as mentioned above, in general, the electric battery pack 500 (and/or the electric battery unit 200) comprises one or more contactors 506 switchable between an open position and a closed position. As mentioned above, when the contactor 506 is in the closed position, the contactor 506 is configured to conduct an electric current or allow an electric current to pass. When the contactor 506 is in the open position, the contactor 506 is configured to interrupt an electric current, or an electrical conductivity, such that no electric current can pass through the contactor 506. In general, the one or more contactors 506 of the electric battery pack 500 (and/or electric batter unit 200) is/are controlled by a battery management system 508, BMS, which is a control system for controlling the electric battery pack 500 (and/or the electric battery unit 200). The battery management system 508 may be connected to and communicate with the above-mentioned cell module controller, CMC, 206 of the electric battery unit 200. The battery management system 508 may be configured to determine and/or measure the voltage upstream (before) and downstream (after) of the one or more contactors 506, for example at voltage measurement points or locations, for example by the aid of one or more sensors. In general, when the battery management system 508 is deactivated, or not turned on, which in general is the case before the electric battery pack 500 (and/or the electric battery unit 200) is electrically connected to the electrical system, the contactor 506 cannot switch to the closed position. Because of this, it is possible to short-circuit the electric battery pack 500 in a controlled manner, for example at a previous stage.

With reference to FIG. 4, in general, when the battery management system 508 is activated or active, a pre-charging of an electrical system (such as the VCB) is essentially always performed before all contactors 506 are closed, for example with the aid of a pre-charge contactor 510 switchable between an open position and a closed position. The pre-charging procedure may include closing one of the contactors 506, and subsequently closing the pre-charge contactor 510, whereupon pre-charging of the electrical system (for example pre-charging of capacitors of the electrical system) is performed. When the voltage downstream of the contactors 506 is determined to be essentially equal to the voltage upstream of the contactors 506 (for example a difference less than 10 V), the other one of the contactors 506 is closed and the pre-charge contactor 510 is opened. Now, the electric battery pack 500 is essentially electrically connected to the electrical system (for example the VCB). Pre-charging of a high voltage direct current system is known to the person skilled in the art and is thus not discussed in further detail. More specifically for the embodiments disclosed herein, this pre-charging will fail if the electric battery pack 500 (and/or the electric battery unit 200) is locally short-circuited by a local short-circuit, because there will be a short-circuit downstream of the one or more contactors 506 (and because of the downstream short-circuit, the voltage will not increase when the pre-charge contactor 510 is closed), and one or more of the contactors 506 will therefore remain in the open position even if the battery management system 508 is activated.

With reference to FIG. 4, in general, the electric battery pack 500 (and/or the electric battery unit 200) comprises an electric battery pack fuse 512, or an electric battery fuse, which, for example, may be a melt fuse, or a pyrotechnic fuse (or pyro fuse), for protection. The pyrotechnic fuse is functional only when the battery management system 508 is active. In general, if the one or more contactors 506 are closed because the battery management system 508 is active, then the local-short circuit of the electric battery pack 500 (and/or the electric battery unit 200) will make the electric battery pack fuse 512 (or the electric battery fuse) to interrupt the electric current path, or the electrical conductivity, of the electric battery pack 500 (and/or the electric battery unit 200), for example by the melting of the electric battery pack fuse 512.

Thus, with reference to FIG. 4, when the electric battery pack 500 (and/or the electric battery unit 200) is locally short-circuited by a local short-circuit, then it is basically assured that either the one or more contactors 506 is/are in the open position or the electric battery pack fuse 512 (or electric battery fuse) has interrupted the electric current path, or the electrical conductivity, for example melted, whereby the electric current path, or the electrical conductivity, of the electric battery pack 500 (and/or the electric battery unit 200) is interrupted. It is to be understood that the electric battery pack 500 may include additional electrical components or equipment known to the person skilled in the art, such as sensors, but these are left out for illustrative purposes.

FIG. 5 schematically illustrates a vehicle electrical system 300 of a vehicle 400. In FIG. 5, the vehicle 400 is illustrated as a tractor vehicle. However, in other embodiments, the vehicle 400 may, for example, be a bus, a truck, or a car. Other types of vehicles are also possible. The vehicle 400 may be an electric vehicle, EV, for example a hybrid vehicle or a hybrid electric vehicle, HEV, or a battery electric vehicle, BEV. It is to be understood that the vehicle 400 may include further unites, components, such as electrical and/or mechanical components, and apparatuses required for a vehicle 400, such as for an EV, HEV or BEV.

With reference to FIG. 5, the vehicle 400 may be a wheeled vehicle, i.e. a vehicle 400 having wheels 462. Only the wheels 462 on the left-hand side of the vehicle 400 are visible in FIG. 5. It is to be understood that the vehicle 400 may have fewer or more wheels than what is shown in FIG. 5. The vehicle 400 may comprise a powertrain 464, for example configured for one of an EV, HEV and BEV.

With reference to FIG. 5, the vehicle 400 comprises a vehicle electrical system 300. The vehicle electrical system 300 may be electrically connectable to one or more electric batteries, for example one or more electrical battery units 200. The vehicle electrical system 300 may be a vehicle high voltage system (VCB) and may be referred to as a VCB. In general, the electric power, or the electric current, of a vehicle high voltage system is transferred at a high voltage, for example above 60 V, such as above 400 V. Thus, when the vehicle electrical system 300 is a vehicle high voltage system (VCB), the vehicle electrical system 300 may be configured for a high voltage above 60 V, for example above 400 V. The vehicle electrical system 300 may be configured for a high voltage up to 1500 V. The vehicle electrical system 300 may further be configured for direct current.

The present invention is not limited to the above described embodiments. Instead, the present invention relates to, and encompasses all different embodiments being included within the scope of the appended independent claim.

1. A method for connecting one or more electric battery units to an electrical system, where the one or more electric battery units having two terminals, wherein the method comprises:
maintaining a system short-circuit which short-circuits the electrical system ;
while the system short-circuit is maintained, electrically connecting a first electric battery unit, which is locally short-circuited by a local short-circuit, to the electrical system so as to include the first electric battery unit in the electrical system; and
while the system short-circuit is maintained, removing the local short-circuit of the first electric battery unit, whereupon the first electric battery unit is short-circuited by the system short-circuit of the electrical system.

2. A method according to claim 1, wherein the method comprises:
receiving the first electric battery unit already locally short-circuited by the local short-circuit.

3. A method according to claim 1, wherein the step of electrically connecting the first electric battery unit comprises electrically connecting a first electric battery unit where the two terminals of the first electric battery unit are short-circuited by the local short-circuit.

4. A method according to claim 3, wherein the method comprises:
receiving the first electric battery unit with the two terminals already locally short-circuited by the local short-circuit.

5. A method according to claim 3, wherein the step of removing the local short-circuit of the first electric battery unit is performed by removing an electrically conductive member, which when applied is short-circuiting the two terminals of the first electric battery unit.

6. A method according to claim 5, wherein the electrically conductive member is external to the first electric battery unit when the electrically conductive member is applied to the first electric battery unit .

7. A method according to claim 1, wherein the connection of the first electric battery unit is part of an electrical system installation procedure, and wherein the removal of the local short-circuit of the first electric battery unit is performed during the electrical system installation procedure.

8. A method according to claim 1, wherein the step of electrically connecting the first electric battery unit, which is locally short-circuited by the local short-circuit, to the electrical system is performed before the step of removing the local short-circuit of the first electric battery unit.

9. A method according to claim 1, wherein the step of removing the local short-circuit of the first electric battery unit, which is locally short-circuited by the local short-circuit, is performed before the step of electrically connecting the first electric battery unit to the electrical system.

10. A method according to claim 1, wherein the method comprises:
while the system short-circuit is maintained, and after the step of electrically connecting the first electric battery unit to the electrical system and after the step of removing the local short-circuit of the first electric battery unit, electrically connecting a further electric battery unit, which is locally short-circuited by a local short-circuit, to the electrical system so as to include the further electric battery unit in the electrical system; and
while the system short-circuit is maintained, and after the step of electrically connecting the first electric battery unit to the electrical system and after the step of removing the local short-circuit of the first electric battery unit, removing the local short-circuit of the further electric battery unit, whereupon the further electric battery unit is short-circuited by the system short-circuit of the electrical system.

11. A method according to claim 10, wherein the method comprises removing the system short-circuit of the electrical system after one or more of the steps of the following group of steps:
electrically connecting the first electric battery unit and removing the local short-circuit of the first electric battery unit; and
electrically connecting the further electric battery unit and removing the local short-circuit of the further electric battery unit.

12. A method according to claim 11, wherein the step of removing the system short-circuit is performed by removing a second electrically conductive member which when applied is short-circuiting the electrical system.

13. A method according to claim 11, wherein the step of removing the system short-circuit is performed when one or more of the situations of the following group of situations is/are valid:
no galvanically exposed electrical conductor present in the electrical system;
a circuit breaker, which is included in and electrically connected to the electrical system and is switchable between an open position and a closed position, is in the open position;
one or more contactors, the contactor being included in one or more of the first and further electric battery units and switchable between an open position and a closed position, is/are in the open position; and/or
a component interrupts the electrical conductivity in the electrical system.

14. A method according to claim 1, wherein the method comprises:
before maintaining the system short-circuit of the electrical system, short-circuiting the electrical system so as to establish the system short-circuit of the electrical system.

15. A method according to claim 1, wherein the electrical system is a vehicle electrical system of a vehicle.

16. A method according to claim 1, wherein the electrical system is a vehicle high voltage system of a vehicle.

17. A method according to claim 1, wherein at least one of the one or more electric battery units one of:
an electric battery; and
an electric battery pack.
